(19) United States
(12) Patent Application Publication
(10) Pub. No.: US 2003/0156769 A1
(43) Pub. Date: Aug. 21, 2003

(54) Fluid suspended bearing

(76) Inventor: Cheol H. Whang, Los Angeles, CA (US)

Correspondence Address: PARK & SUTTON LLP, 3255 WILSHIRE BLVD, SUITE 1110, LOS ANGELES, CA, 90010, US

(21) Appl. No.: 10/077,734

(22) Filed: Feb. 19, 2002

(51) Int. Cl. F16C 33/10

(52) U.S. Cl. 384/291

(57) ABSTRACT

An oil-lubricated sliding bearing is provided. The bearing comprises a first member having a sliding surface having at least one groove, and a second member having a sliding surface having at least one groove. The sliding surface of the first member and the sliding surface of the second member slide on each other. The first member is fixed and the second member is movable. The grooves of the first member are inclined from the sliding direction. The bearing includes a linear bearing, a radial bearing, a taper bearing, and a thrust bearing.

### BACKGROUND OF THE INVENTION

The present invention relates to a sliding bearing.

More particularly, the invention relates to an oil-lubricated sliding bearing which has grooves for retaining oil.

Bearings are used for preventing wear of the rotating parts of a machine and for reducing frictional resistance. Types of bearings include ball bearings and roller bearings that use rolling friction, and sliding bearings that use sliding friction.

The metal bearing is a kind of sliding bearings and supplies oil to form an oil film with a bearing surface and a journal surface. The oil film lubricates the surfaces, and prevents adhesion and wear of the surfaces. Bearing performance of metal bearings is enhanced by plating the bearing surface with various alloys to prevent friction and wear and to increase load-bearing capacity. Metal bearings include babbit metal bearing, kelmet alloy bearing, and white metal bearing, etc. Proper functioning of the metal bearing requires continuous lubrication oil supply and a constant rotation speed. In particular, at the start of rotation, oil is not supplied yet and there is no oil film. Thus, adhesion between the bearing surface and the journal surface tends to occur increasing the frictional coefficient and wear. When the pressure applied on the bearing is too high, proper bearing performance is not achieved since the oil film between the bearing surface and the journal surface is broken and complete lubrication is not kept.

Accordingly, there has been a demand for an improved sliding bearing to keep bearing functions even under conditions adverse to proper lubrication between sliding surfaces of sliding bearings.

### SUMMARY OF THE INVENTION

The present invention is contrived to overcome the conventional disadvantages. Therefore, an object of the invention is to provide an enhanced lubrication oil retaining structure for a sliding bearing.

Another object of the invention is to provide an improved oil supply structure to form an oil film.

Still another object of the invention is to provide a sliding bearing having oil-retaining grooves arranged to use the dynamic force of the bearing rotation.

To achieve the above-described objects, in accordance with an embodiment thereof, the invention provides an oil-lubricated sliding bearing that comprises a first member having a sliding surface and a second member having a sliding surface. Each of the sliding surfaces has at least one groove. The sliding surface of the first member and the sliding surface of the second member slide on each other. The first member is fixed and the second member is movable. The grooves of the first member are inclined from the sliding direction.

At least one holes to supply oil is provided on the sliding surface of the first member or the second member. The number of the holes is between about two (2) and about four (4).

The sliding surfaces are plated with hard chrome plating or coated with ceramic coating.

In one aspect of the invention, the sliding bearing is a linear bearing. In this aspect, each of the grooves of the first member extends between the centerline and the edges of the sliding surface and is spaced from the centerline and the edges. The grooves left to the centerline are symmetrical with the grooves right to the centerline. The groove of the second member has an “H” shape.

In another aspect of the invention, the sliding bearing is a radial bearing. In this aspect, each of the grooves of the first member extends between the centerline and the edges of the sliding surface and is spaced from the centerline and the edges. The grooves left to the centerline are symmetrical with the grooves right to the centerline. The grooves of the second member comprises a circumferential groove formed on the center line of the sliding surface and a plurality of inclined grooves that are connected to the circumferential groove and are spaced from the edges of the sliding surface. The inclined grooves left to the circumferential groove are symmetrical with the inclined grooves right to the circumferential groove. The number of the inclined grooves of the second member is between about four (4) and about sixteen (16).

In still another aspect of the invention, the sliding bearing is a thrust bearing. In this aspect, each of the grooves of the first member has a spiral shape and is spaced from the center and edge of the sliding surface. The grooves of the second member are radial and each of the grooves is spaced from the edge of the sliding surface. The number of the grooves of the second member is between about three (3) and about six (6).

In still another aspect of the invention, the sliding bearing is a taper bearing, Each of the grooves of the first member extends between the center line and the edges of the sliding surface and is spaced from the center line and the edges. The grooves left to the centerline are symmetrical with the grooves right to the centerline. The grooves of the second member comprises a circumferential groove formed on the center line of the sliding surface and a plurality of inclined grooves that are connected to the circumferential groove and are spaced from the edges of the sliding surface. The inclined grooves left to the circumferential groove are symmetrical with the inclined grooves right to the circumferential groove.

In accordance with another embodiment thereof, the invention provides an oil-lubricated sliding bearing that comprises first member having a sliding surface and a second member having a sliding surface. Each of the sliding surfaces has at least one groove. The sliding surface of the first member and the sliding surface of the second member slide on each other. The first member is fixed and the second member is movable. The grooves of the first member are inclined from the sliding direction. At least one oil-supplying hole is provided in the grooves.

The advantages of the present invention are numerous in that: (1) The sliding bearing may be made with tighter dimensions; (2) frictional wear is minimized; (3) lubrication state is enhanced; and (4) load bearing capacity increases.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is an illustrative view of a linear bearing according the present invention;

FIG. 2 is a plan view of a bearing of the linear bearing;

FIG. 3 is a plan view of a slider of the linear bearing;

FIG. 4 is an elevational view of a journal of a radial bearing;

FIG. 5 is an illustrative view of a bearing of a radial bearing;

FIG. 6 is a detail view of the circled portion of FIG. 5;

FIG. 7 is an illustrative view that shows a section of a groove;

FIG. 8 is an illustrative view of a thrust bearing;

FIG. 9 is a plan view of a bearing of the thrust bearing;

FIG. 10 is a plan view of a journal of the thrust bearing;

FIG. 11 is an illustrative view of a bearing of a taper bearing;

FIG. 12 is an illustrative view of a journal of the taper bearing; and

FIG. 13 is a sectional view taken along 13-13 in FIG. 11.

### DETAILED DESCRIPTION OF THE PREFERRED EMBODIMENTS

An oil-lubricated sliding bearing according to the present invention comprises a bearing and a journal. The bearing surrounds the journal and the journal is received in the bearing. Normally, the bearing is fixed and the journal rotates in the bearing. The bearing has a sliding surface that slides on a sliding surface of the journal. Each of the sliding surfaces has at least one groove for retaining oil. The grooves of the bearing are inclined from the sliding direction. The dimensions of the grooves, such as depth, width, and length, and the number of the grooves are determined according to the load bearing conditions. At least one hole for supplying oil is provided on the sliding surfaces. The hole may be provided in the grooves or on the part of the sliding surface where there is no groove. Preferably, the number of the oil supply holes is in the range between two (2) and four (4).

The sliding surfaces of the bearings or journals may be coated with ceramic coating, or plated with hard chrome plating in order to prevent wear.

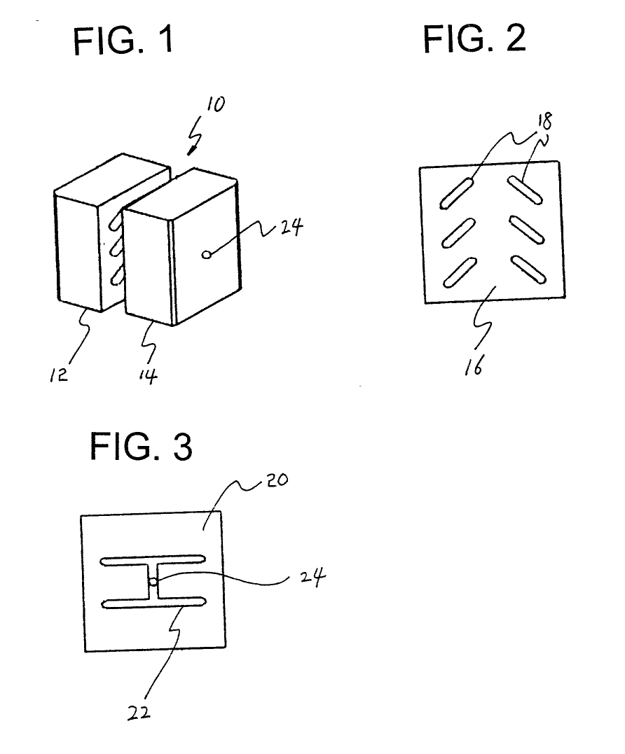

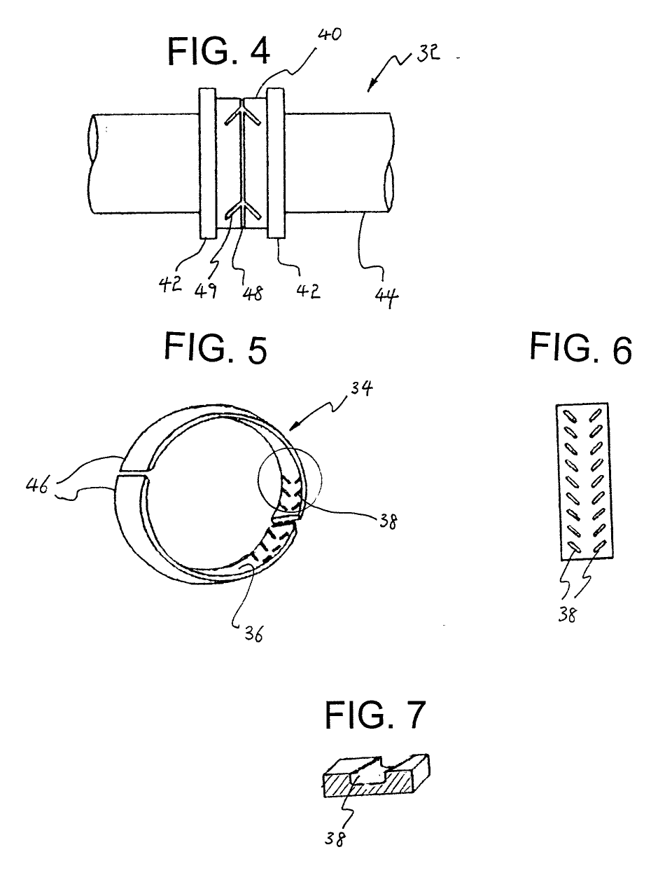

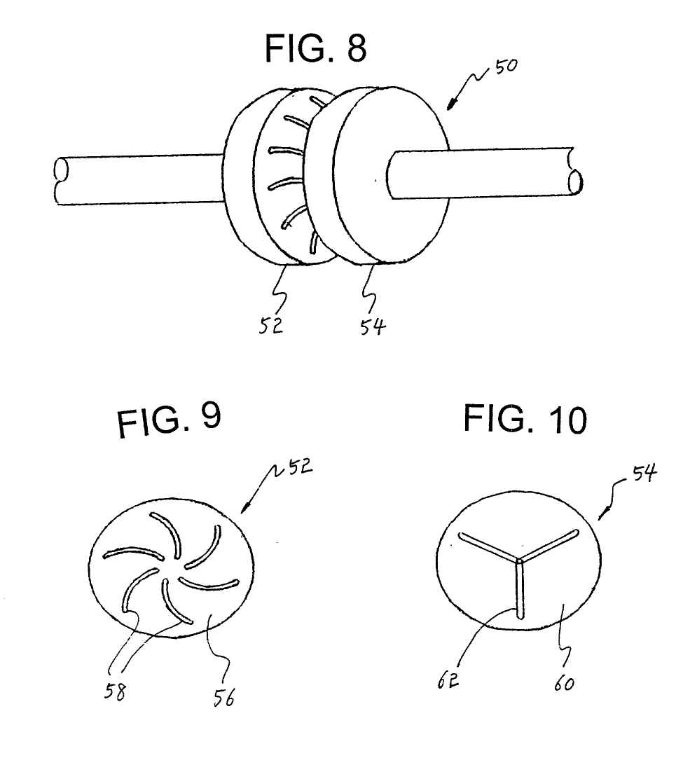

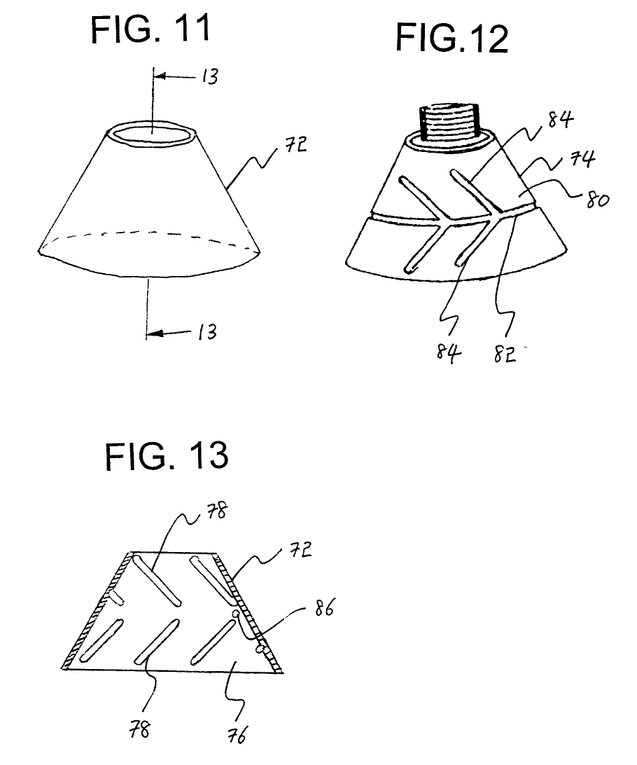

The sliding bearing of the present invention includes various types of bearings. FIGS. 1-3 illustrate a linear bearing 10. FIGS. 4-7 illustrate a journal 32 and a bearing 34 of a radial bearing. FIGS. 8-10 illustrate a thrust bearing 50. FIGS. 11-13 illustrate a bearing 72 and a journal 74 of a taper bearing.

As shown in FIGS. 1-3, the linear bearing 10 according to the present invention includes a bearing 12 and a slider 14. The bearing 12 and the slider 14 slide on each other. Usually, the bearing 12 is fixed and the slider 14 moves reciprocally along a straight line.

The bearing 12 has a sliding surface 16, and the sliding surface 16 has at least one groove 18. The grooves 18 are arranged to extend between the centerline and the edges of the sliding surface 16. The grooves 18 are spaced from the centerline and the edges of the sliding surface 16 so that there are no open ends of the grooves and oil is retained in the grooves. The grooves left to the centerline are symmetrical with the grooves right to the centerline.

The slider 14 has a sliding surface 20. The sliding surface 20 has a groove 22 that has an “H” shape. An oil supply hole 24 is shown in the groove 22.

As shown in FIGS. 4-6, the radial bearing according to the present invention includes a journal 32 and a bearing 34. The bearing 34 has a sliding surface 36, and the sliding surface 36 has at least one groove 38. The grooves 18 are arranged to extend between the centerline and the edges of the sliding surface 36. The grooves 38 are spaced from the centerline and the edges of the sliding surface 36. The grooves 38 left to the centerline are symmetrical with the grooves 38 right to the centerline.

The journal 32 has a sliding surface 40, two flanges 42, and a shaft 44. The flanges 42 are positioned at both sides of the sliding surface 40. The bearing 34 is made of two halves 46. The bearing 34 may also be made of a single part. The halves 46 surround the sliding surface 40 of the journal 32. The halves 46 are enclosed in a bearing housing (not shown). The sliding surface 40 has a circumferential groove 48 formed on its centerline and a plurality of inclined grooves 49 that are connected to the circumferential groove 48 and are spaced from the edges of the sliding surface 40. The inclined grooves 49 left to the circumferential groove 48 are symmetrical with the inclined grooves 49 right to the circumferential groove 48. Preferably, the number of the inclined grooves 49 is in the range between four (4) and sixteen (16). That is, the inclined grooves 49 form two (2) through eight (8) arrow-shaped grooves. The arrows are directed toward the main direction of rotation.

FIG. 7 illustrates a section of the groove 38. Other grooves have a similar sectional shape.

As shown in FIGS. 8-10, the thrust bearing 50 according to the present invention includes a bearing 52 and a journal 54. The bearing 52 has a sliding surface 56, and the sliding surface 56 has at least one spiral groove 58. The spiral grooves 58 are spaced from the center and edges of the sliding surface 56.

The journal 54 has a sliding surface 60. The sliding surface 60 has radial grooves 62. The radial grooves 62 merge at the center of the sliding surface 60 and are spaced from the edges of the sliding surface 60. Preferably, the number of the grooves 62 is in the range between three (3) and six (6).

As shown in FIGS. 11-13, the taper bearing of the present invention includes a bearing 72 and a journal 74. The bearing 72 is enclosed in a bearing housing (not shown). The bearing 72 has a sliding surface 76. The sliding surface 76 has inclined grooves 78. Each of the inclined grooves 78 extends between the centerline and the edges of the sliding surface 76 and is spaced from the centerline and the edges. The grooves 78 left to the centerline are symmetrical with the grooves 78 right to the centerline.

The journal 74 has a sliding surface 80. The sliding surface 80 has a circumferential groove 82 formed on its centerline and a plurality of inclined grooves 84 that are connected to the circumferential groove 82 and are spaced from the edges of the sliding surface 80. The inclined grooves 84 left to the circumferential groove 82 are symmetrical with the grooves 84 right to the circumferential groove 82. An oil supply hole 86 is shown on the sliding surface 76.

The geometric shape of the grooves of the sliding bearing according to the present invention forms a strong lubrication oil film using the supply pressure of the oil and the force exerted by the movement of the journal relative to the bearing. That is, the oil film retains the pressure generated by the oil supply pressure and momentum generated by the journal movement, and the pressure and the momentum keeps the oil film strong. The inclined grooves of the bearing and the circumferential groove and the arrow-shaped grooves of the journal help to keep the pressure and momentum. The grooves provide reservoir spaces for oil and passages for oil flow. Since the grooves have no open ends at edges of the sliding surfaces, the pressure exerted on the lubrication oil retained in the groove is preserved.

Lubrication oil is an incompressible fluid. Oil retained in the grooves of the bearing is not compressed even though a local load is applied on the oil. Thus, adhesion of the sliding surfaces of the bearing and the journal is difficult to occur.

When a big, local pressure is exerted on a bearing area, the flexibility of the bearing material and the oil retained in the groove absorb the pressure and use the pressure to reform an oil film, thus relieving the impact.

Even if oil leaks between a gap between the sliding surfaces of the bearing and the journal, passing through the narrow space causes resistance by hydraulic head loss and shear stress, and thus, the oil film formed between the sliding surfaces is not easily broken. Also, surface tension applied on the oil retained in the groove helps to keep the oil in the groove without losing it. Meniscuses are formed by surface tension on the surface of the oil. When a meniscus of the oil retained in the groove of the bearing meets a meniscus of the oil retained in the groove of the journal, they forms an oil film effectively.

The oil retained in the grooves prevents a boundary lubrication state and provides an instant lubrication when the journal starts to rotate. The higher the oil supply pressure is, the stronger the formed oil film is, and the sliding surface of the bearing and the sliding surface of the journal are supported stably and balanced to further increase the load capacity of the sliding bearing. This keeps the bearing performance even in a low speed condition.

The arrow-shaped grooves of the journal spread a strong oil film on the sliding surfaces. The oil film has a high pressure provided by the oil supply pressure. The pressure and flow speed of the oil film sweep hard particles and foreign materials that cause wear into the grooves. The centrifugal force generated by the rotation of the journal causes hard particles and foreign materials, which have a specific weight bigger than that of oil into the grooves, to be collected in the grooves, and then they are eliminated out of the sliding bearing by the oil pressure and momentum given by the shape of the grooves. The oil retained in the grooves cools down the sliding surfaces by eliminating frictional heat and reduces hardening fatigue wear that occurs in the metal that forms the sliding surface of the journal, thus minimizing wear.

With the above construction, the gap between the sliding surface of the bearing and the sliding surface of the journal may be reduced from the range between 0.03 mm and 0.1 mm to the range between 0.02 mm and 0.03 mm, which provides more precise rotation. Other advantages of the present invention are: wear is minimized; the frictional coefficient decreases providing better lubrication; and the load bearing capacity increases.

Although the invention has been described in considerable detail, other versions are possible by converting the aforementioned construction. Therefore, the scope of the invention shall not be limited by the specification specified above and the appended claims.

What is claimed is:

1. An oil-lubricated sliding bearing comprising:
a) a first member having a sliding surface, the sliding surface having at least one groove,
b) a second member having a sliding surface, the sliding surface having at least one groove,
wherein the sliding surface of the first member and the sliding surface of the second member slide on each other, wherein the first member is fixed and the second member is movable, and wherein the grooves of the first member are inclined from the sliding direction.

2. The oil-lubricated sliding bearing of claim 1
wherein the surface of first member further comprises at least one hole to supply oil.

3. The oil-lubricated sliding bearing of claim 2
wherein the number of the holes is between about two (2) and about four (4).

4. The oil-lubricated sliding bearing of claim 1
wherein the surface of second member further comprises at least one hole to supply oil.

5. The oil-lubricated sliding bearing of claim 4
wherein the number of the holes is between about two (2) and about four (4).

6. The oil-lubricated sliding bearing of claim 1
wherein the sliding surfaces are plated with hard chrome plating.

7. The oil-lubricated sliding bearing of claim 1
wherein the sliding surfaces are coated with ceramic coating.

8. The oil-lubricated sliding bearing of claim 1
wherein the bearing is a linear bearing,
wherein each of the grooves of the first member extends between the center line and the edges of the sliding surface and is spaced from the center line and the edges, wherein the grooves left to the center line are symmetrical with the grooves right to the center line, and
wherein the groove of the second member has an “H” shape.

9. The oil-lubricated sliding bearing of claim 1
wherein the bearing is a radial bearing,
wherein each of the grooves of the first member extends between the center line and the edges of the sliding surface and is spaced from the center line and the edges, wherein the grooves left to the center line are symmetrical with the grooves right to the center line,
wherein the grooves of the second member comprises a circumferential groove formed on the center line of the sliding surface and a plurality of inclined grooves that are connected to the circumferential groove and are spaced from the edges of the sliding surface, and wherein the inclined grooves left to the circumferential groove are symmetrical with the inclined grooves right to the circumferential groove.

10. The oil-lubricated sliding bearing of claim 9
wherein the number of the inclined grooves of the second member is between about four (4) and about sixteen (16).

11. The oil-lubricated sliding bearing of claim 1 p1 wherein the bearing is a thrust bearing,
wherein each of the grooves of the first member has a spiral shape and is spaced from the center and edge of the sliding surface, and
wherein the grooves of the second member are radial and each of the grooves is spaced from the edge of the sliding surface.

12. The oil-lubricated sliding bearing of claim 11
wherein the number of the grooves of the second member is between about 3 and about 6.

13. The oil-lubricated sliding bearing of claim 1
wherein the bearing is a taper bearing,
wherein each of the grooves of the first member extends between the center line and the edges of the sliding surface and is spaced from the center line and the edges, wherein the grooves left to the center line are symmetrical with the grooves right to the center line,
wherein the grooves of the second member comprises a circumferential groove formed on the center line of the sliding surface and a plurality of inclined grooves that are connected to the circumferential groove and are spaced from the edges of the sliding surface, and wherein the inclined grooves left to the circumferential groove are symmetrical with the inclined grooves right to the circumferential groove.

14. An oil-lubricated sliding bearing comprising:
a) a first member having a sliding surface, the sliding surface having at least one groove,
b) a second member having a sliding surface, the sliding surface having at least one groove,
wherein the sliding surface of the first member and the sliding surface of the second member slide on each other, wherein the first member is fixed and the second member is movable, wherein the grooves of the first member are inclined from the sliding direction, and wherein at least one oil supplying hole is provided in the grooves.

15. The oil-lubricated sliding bearing of claim 14
wherein the sliding surfaces are plated with hard chrome plating.

16. The oil-lubricated sliding bearing of claim 14
wherein the sliding surfaces are coated with ceramic coating.

17. The oil-lubricated sliding bearing of claim 14
wherein the bearing is a linear bearing,
wherein each of the grooves of the first member extends between the center line and the edges of the sliding surface and is spaced from the center line and the edges, wherein the grooves left to the center line are symmetrical with the grooves right to the center line, and
wherein the groove of the second member has an “H” shape.

18. The oil-lubricated sliding bearing of claim 14
wherein the bearing is a radial bearing,
wherein each of the grooves of the first member extends between the center line and the edges of the sliding surface and is spaced from the center line and the edges, wherein the grooves left to the center line are symmetrical with the grooves right to the center line,
wherein the grooves of the second member comprises a circumferential groove formed on the center line of the sliding surface and a plurality of inclined grooves that are connected to the circumferential groove and are spaced from the edges of the sliding surface, and wherein the inclined grooves left to the circumferential groove are symmetrical with the inclined grooves right to the circumferential groove.

19. The oil-lubricated sliding bearing of claim 14
wherein the bearing is a thrust bearing,
wherein each of the grooves of the first member has a spiral shape and is spaced from the center and edge of the sliding surface, and
wherein the grooves of the second member are radial and each of the grooves is spaced from the edge of the sliding surface.

20. The oil-lubricated sliding bearing of claim 14
wherein the bearing is a taper bearing,
wherein each of the grooves of the first member extends between the center line and the edges of the sliding surface and is spaced from the center line and the edges, wherein the grooves left to the center line are symmetrical with the grooves right to the center line,
wherein the grooves of the second member comprises a circumferential groove formed on the center line of the sliding surface and a plurality of inclined grooves that are connected to the circumferential groove and are spaced from the edges of the sliding surface, and wherein the inclined grooves left to the circumferential groove are symmetrical with the inclined grooves right to the circumferential groove.
